(19) United States
(12) Patent Application Publication
(10) Pub. No.: US 2021/0191372 A1
(43) Pub. Date: Jun. 24, 2021

(54) ANALYSIS OF ADDITIVE MANUFACTURING PROCESSES

(71) Applicant: SIEMENS MOBILITY GMBH, MUENCHEN (DE)

(72) Inventor: MAXIMILIAN KUNKEL, HERZOGENAURACH (DE)

(21) Appl. No.: 16/762,585

(22) PCT Filed: Oct. 10, 2018
(86) PCT No.: PCT/EP2018/077541

§ 371 Date: May 8, 2020

(30) Foreign Application Priority Data
Nov. 8, 2017 (DE) 102017219860

(51) Int. Cl. G05B 19/418; G01N 21/55; B33Y 50/02

(52) U.S. Cl. CPC G05B 19/41875; B29C 64/153; B33Y 50/02; G01N 21/55

(57) ABSTRACT

A method and a device for analyzing an additive manufacturing process. In the method, measurement values for at least one process emission are detected during the manufacture of a workpiece. Standard deviations of the measurement values of predefined volume elements of the workpiece are calculated, and a distribution of the calculated standard deviations of multiple predefined volume elements is analyzed as a measure of the process quality.

The invention relates to a method and a device for analyzing and/or monitoring additive manufacturing processes, in particular laser-based processes, in particular powder bed processes, wherein measurement values concerning at least one process emission are detected.

Additive manufacturing processes can be classified in various ways.

In this regard, laser-based additive manufacturing processes or laser additive manufacturing processes use a laser as selectively acting tool. So-called powder bed-based 3D printing processes, also called powder bed processes (powder bed fusion processes, PBF processes for short), in particular laser beam melting and laser sintering processes, are likewise sufficiently known to the person skilled in the art of additive manufacturing. Powder layers are deposited in a defined manner and then thermally sintered or fused, in particular by means of electromagnetic radiation, e.g. a laser. After the printing process, the components are freed of powder. Besides laser-based powder bed processes, process emissions can arise and be detected during so-called electron beam melting as well.

In particular for the process assessment of laser-based processes and/or powder bed processes (PBF processes), in particular of laser beam melting processes, systems are known which afford the possibility of capturing various measurement values (e.g. protective gas profile, build chamber temperature, laser power). The data analysis and assessment are incumbent on the user, however. A multiplicity of possible influencing factors have to be assessed in this case.

Specifically with regard to melt pool monitoring systems, the process luminous emission can be captured in various ways (on-axis/off-axis) using a wide variety of measuring instruments (pyrometer, bolometer, thermographic camera, photodiodes, high-speed cameras (CCD/CMOS)). For the data evaluation, by contrast, no suitable, meaningful analysis methods or algorithms which allow the process quality and thus the expected component properties to be deduced directly have been known heretofore. The current prior art is limited mainly to simple outputs of the detected average values and variances or the simple output of generated layer images (melt pool maps). These are then intended to be assessed by the user by “comparison”.

The invention is based on the object of proposing a method for assessing component properties on the basis of measured process values.

The object is achieved by means of the subjects of the independent patent claims. Developments and configurations of the invention are found in the features of the dependent patent claims.

A method according to the invention for analyzing and/or monitoring an additive manufacturing process, in particular a laser-based manufacturing process, in particular a laser beam melting process, during the, for example layer-by-layer manufacture of a workpiece or for analyzing and/or monitoring a workpiece produced layer by layer by a powder bed process, in particular, comprises the following method steps:
detecting measurement values concerning at least one process emission during the manufacture of the workpiece, in particular detecting measurement values concerning at least one measurement variable representing process luminous emission,
calculating average values and standard distributions from the measurement values for a plurality of predefined volume elements of the workpiece, and
checking the distribution of the standard distributions of the predefined volume elements as a measure of the process quality, in particular checking whether the distribution of the standard distributions is a normal distribution.

Process emissions occur in particular in the form of radiation, in particular electromagnetic wave radiation, and are detected in a predefined band, in particular in a predefined electromagnetic wave spectrum. One form of a process emission is the so-called process luminous emission. It occurs for example during laser beam melting as a result of partly ionized, vaporized powder, which vapor escapes from the melt pool and emits broadband luminous emission, usually in the near infrared range. The process luminous emission can be regarded as a kind of signature for the melting process since every material emits differently.

A device according to the invention for analyzing an additive manufacturing process and for analyzing a workpiece produced, in particular layer by layer, by the additive manufacturing process correspondingly comprises at least one suitably configured measurement value pickup for detecting measurement values concerning at least one process emission during the manufacture of the workpiece, in particular for detecting measurement values concerning at least one measurement variable representing the process luminous emission.

In accordance with a further development, reflection values of the melt pool are detected as measurement values, in particular by a photodiode and/or by a high-speed camera. A developed device correspondingly comprises at least one photodiode and/or a high-speed camera.

Advantageously, measurement values concerning a plurality of measurement variables can be detected and evaluated in accordance with the method described.

A suitable monitoring system comprises for example a pyrometer, a bolometer, a thermographic camera, a photodiode and/or a high-speed camera (CCD/CMOS) for detecting reflection values of the melt pool that represent the process luminous emission. These can be stored per layer in a manner related to the melt pool position, in order subsequently to be able to be evaluated by means of the suitable computing unit.

Here in each case a plurality of measurement values concerning a plurality of predefined volume elements of the workpiece are detected. Here the individual volume elements of the workpiece do not have to be of the same size and accordingly it is not necessary to detect and evaluate the same number of measurement values for each volume element. However, as already explained above, the number of measurement values per volume element ought to be large enough for the subsequent statistical evaluation. The number of volume elements per workpiece for analyzing the additive manufacturing process and/or the workpiece is also correspondingly predefined.

In accordance with one development of the invention, the workpiece is manufactured layer by layer, for example by a powder bed process. One volume element of the workpiece can correspond to exactly one layer of the workpiece manufactured layer by layer. In the case of different layer sizes, in particular as a result of surface areas of different magnitudes of the individual layers, the individual, predefined volume elements of the workpiece then differ in size or comprise different numbers of measurement values. In principle, however, arbitrary points, lines or areas of a layer of the workpiece manufactured layer by layer could be predefined as volume elements; since a layer always has a minimum layer thickness and width dependent in particular on a powder size of the starting material used, even arbitrary points or lines have a volume. The measurement values lie in a layer and can thus be represented two-dimensionally, but represent volume elements with predefined layer thicknesses. A plurality of volume elements per layer are thus conceivable. In accordance with a further development of the invention, each predefined volume element bounds in each case a predefined area of exactly one layer of the workpiece manufactured layer by layer. In other words, rather than a plurality of layers, only one layer per volume element is encompassed.

Furthermore, at least the volume elements of a layer can be predefined to be of the same size. By means of different layer sizes, it is then possible to obtain different numbers of volume elements per layer. Alternatively, the same number of volume elements per layer could be predefined, but then optionally with mutually different sizes.

In each case an average value and a standard distribution are calculated from the measurement values concerning the process emissions concerning each predefined volume element. Average values and standard distributions are thus present for each volume element, for example each manufactured layer.

The device according to the invention for analyzing an additive manufacturing process and for analyzing a workpiece produced, in particular layer by layer, by the additive manufacturing process therefore furthermore comprises at least one correspondingly suitably configured computing unit for forming average values and standard distributions from the measurement values concerning the individual, predefined volume elements of the workpiece.

Afterward, the distribution of the standard distributions over a number of predefined volume elements, in particular over the entire workpiece and thus encompassing all volume elements and the corresponding standard distributions thereof, is checked as a measure of the process quality. In a development, a check is carried out as to whether the distribution of the standard distributions is a normal distribution. The computing unit of a correspondingly developed device for analyzing an additive manufacturing process and for analyzing a workpiece produced by the additive manufacturing process is correspondingly suitably configured.

In accordance with a further development, a fault-free process is deduced if a normal distribution of the calculated standard distributions of a plurality of predefined volume elements is present. The distribution of the standard distributions represents a measure of the process quality. In the case of a deviation of the calculated standard distributions of a plurality of predefined volume elements from a normal distribution, a fault in the additive manufacturing process during the production of the workpiece is correspondingly deduced.

A further development of the method according to the invention provides for two-dimensional distributions of the calculated standard distributions and of the calculated average values to be checked as to whether they exhibit a normal distribution, in order to deduce the process quality. Thus, firstly tuples are formed from average values and standard distributions concerning the respective volume elements and they are plotted in a two-dimensional coordinate system for a predefined number of volume elements, in particular for all volume elements of the manufactured workpiece. The fact of whether a fault-free production process was present is subsequently deduced from the form of the point cloud.

In a development, the process quality is deduced from the form and position of the point cloud.

A further development of the method according to the invention for analyzing and/or monitoring an additive manufacturing process, in particular a laser-based powder bed process, in particular a laser beam melting process, during the layer-by-layer manufacture of a workpiece or for analyzing and/or monitoring a workpiece produced layer by layer by an additive manufacturing process, in particular a laser-based powder bed process, comprises the following method steps:
detecting measurement values concerning at least one process emission during the manufacture of the workpiece, in particular detecting measurement values concerning at least one measurement variable representing process luminous emission,
calculating average values and standard distributions from the measurement values for a plurality of predefined volume elements of the workpiece,
forming variation coefficients for the respective volume elements,
forming a moving average value of the variation coefficients over a window of predefined volume elements, and
checking whether the moving average value lies within a predefined interval.

A device for analyzing an additive manufacturing process, in particular a powder bed process, and for analyzing a workpiece produced, in particular layer by layer, by the additive manufacturing process, in particular by the powder bed process, comprising at least one computing unit suitably configured for checking a distribution of the calculated standard distributions of a plurality of predefined volume elements as a measure of the process quality, in a development, can be correspondingly suitably configured for
forming variation coefficients for the respective volume elements,
forming a moving average value of the variation coefficients over a window of predefined volume elements, and
checking whether the moving average value lies within a predefined interval.

In particular, the at least one computing unit of the device is correspondingly suitably configured.

Variation coefficients are formed as quotients of the average values and the corresponding standard distributions. The term inverse variation coefficients denotes the reciprocal values thereof, that is to say quotients of standard distributions and average values, which are intended to be deemed likewise to be concomitantly encompassed here.

The moving average value of the variation coefficients or of the inverse variation coefficients over a window of predefined volume elements serves for checking the distribution of the standard distributions of the predefined volume elements. The moving average value of the variation coefficients is thus deemed to be a measure of the distribution of the standard distributions. If it lies within a predefined interval, then it can be assumed that the distribution of the standard distributions is a normal distribution.

If the volume elements in each case depict a layer of the workpiece manufactured layer by layer, then the method steps following detecting the measurement values concerning at least one process emission during the manufacture of the workpiece are:
calculating average values and standard distributions from the measurement values concerning individual layers of the workpiece,
forming variation coefficients for the respective layers,
forming a moving average value of the variation coefficients over a window of predefined layers, and
checking whether the moving average value lies within a predefined interval.

The typical process luminous emission of the melt pool in known powder bed processes, for example in laser beam melting, is detected by a suitable monitoring system, in particular comprising suitable measurement value pickups, and is then evaluated by means of at least one suitable computing unit. Firstly, for each volume element examined, in particular for each layer examined, or each process step of the powder bed process that forms the volume element or respectively the layer, there are formed at least one average value and a standard distribution over a predefined window, for example over a selected region, that is to say over a predefined volume element or over the entire layer. Afterward, the variation coefficients or the inverse variation coefficients are formed for at least one volume element, but in particular for a plurality thereof, for example for each layer. Moving average values of the variation coefficients or of the inverse variation coefficients are calculated over a predefined number of volume elements, in particular directly adjacent volume elements and thus volume elements that are manufactured successively in terms of process engineering. If the moving average value deviates, that is to say if it exceeds a predefined interval, which can likewise be adapted in a moving fashion, then a fault can be identified. The predefined interval can thus specify a corresponding confidence range. The predefined interval could thus also be called a confidence interval. A plurality of mutually different intervals can also be predefined. In this regard, a check is then carried out as to whether the moving average value lies within at least one of the predefined intervals.

In one development of the invention, therefore, if the predefined interval around the variation coefficient or the inverse variation coefficient is exceeded, it is deduced that a fault was present, for example that the melt pool was disturbed and/or that the workpiece is defective. A fault signal can thereupon also be generated and output.

The interval itself can move over a plurality or all of the volume elements. The predefined windows comprise a predefined number of moving average values of variation coefficients and thus represent a predefined number of volume elements. For each window it is thus possible to predefine an interval which differs from intervals of other windows. For example with a rising curve profile, that is to say with increasing moving average values, the limits of the intervals can likewise be predefined as rising. The latter can vary over a plurality of layers and thus over the entire workpiece. Theoretically an adaptation of the interval limits over a layer is also conceivable, depending on the number and size of the predefined windows.

In a development, the interval is predefined as a function of the moving average values over the predefined window. In this case, the interval limits can be predefined as a function of the moving average values over the predefined window, for example they have the same distance around an average of the average values over the predefined window of predefined volume elements.

A further development should be seen in the fact that the variance of the moving average values also and in particular within the predefined interval over the predefined window is checked as a measure of the process quality. The variance or the standard distribution of the moving average values over the predefined window is firstly calculated and then examined. In the case of a small variance, a fault-free process can be deduced.

In accordance with a further development, the profile of the moving average values also and in particular within the predefined interval over the predefined window can be checked as a measure of the process quality.

The invention thus proposes a standardized and targeted procedure for data analysis and the assessment thereof.

The invention permits numerous embodiments. It is explained in greater detail with reference to the following figures, each of which illustrates a configuration example. Identical elements in the figures are provided with identical reference signs.

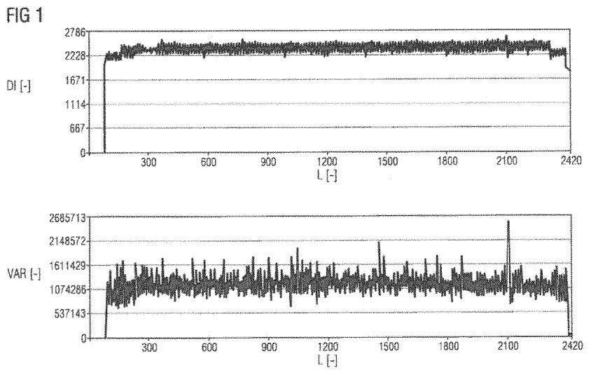

FIG. 1 shows by way of example a curve profile of intensities detected by means of a photodiode and averaged and the variances thereof over individual layers of a component which was assessed as fault-free in later experiments,

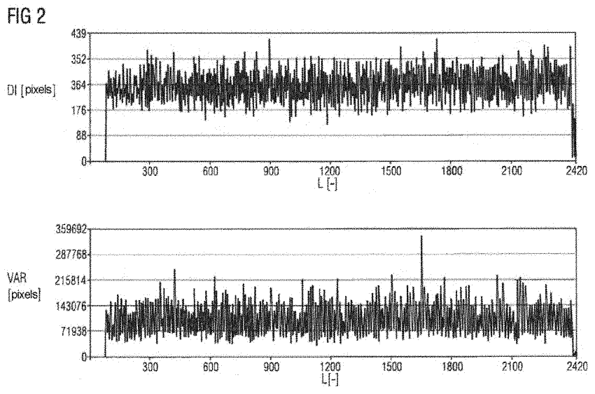

FIG. 2 shows by way of example a curve profile of reflection values detected by means of a high-speed camera and averaged and the variances thereof over individual layers of a component which was assessed as fault-free in later experiments,

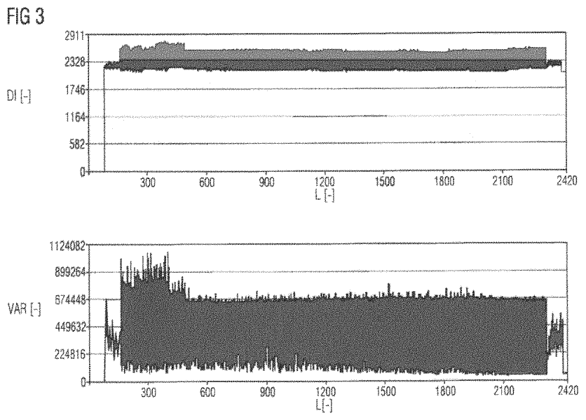

FIG. 3 shows by way of example a curve profile of intensities detected by means of a photodiode and averaged and the variances thereof over individual layers of a component which was assessed as defective in later experiments,

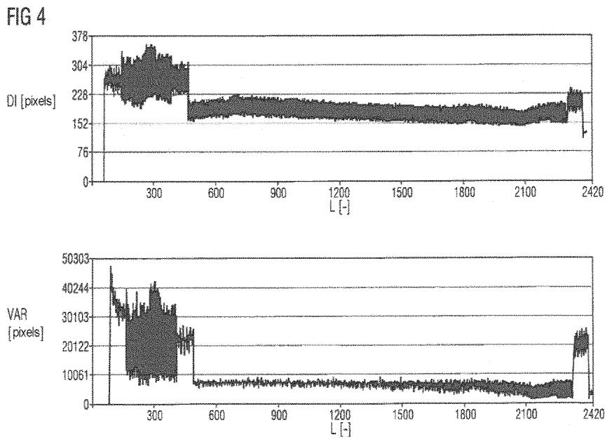

FIG. 4 shows by way of example a curve profile of reflection values detected by means of a high-speed camera and averaged and the variances thereof over individual layers of a component which was assessed as defective in later experiments,

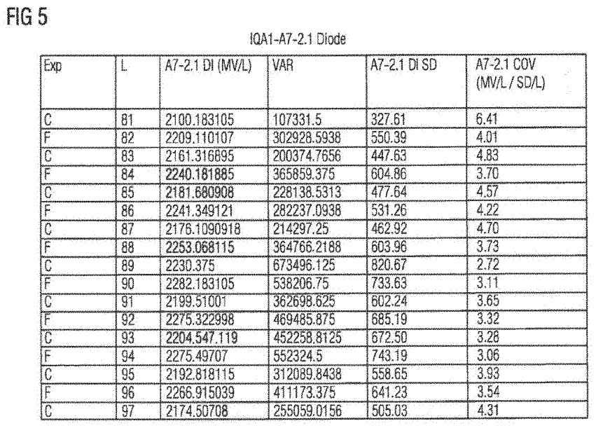

FIG. 5 shows by way of example a data sheet with the average values and variances—derived from the detected measurement values—concerning individual layers of the manufactured component for different exposure steps,

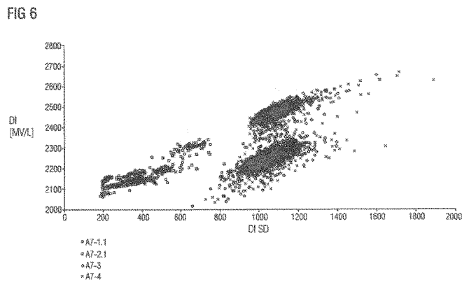

FIG. 6 shows a diagram with values concerning area and contour exposure,

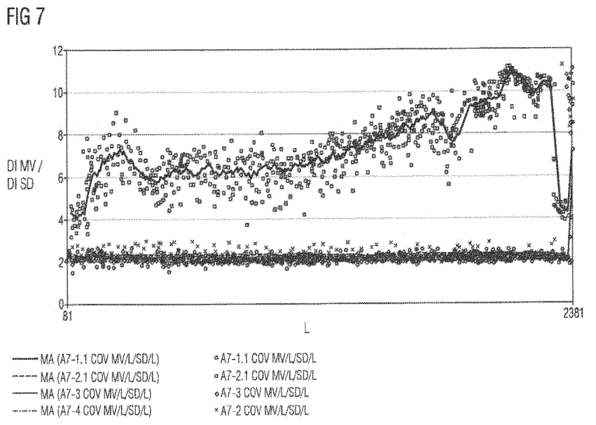

FIG. 7 shows the inverse variation coefficient concerning the measurement values for contour exposure and also a moving average value, plotted against predefined layers,

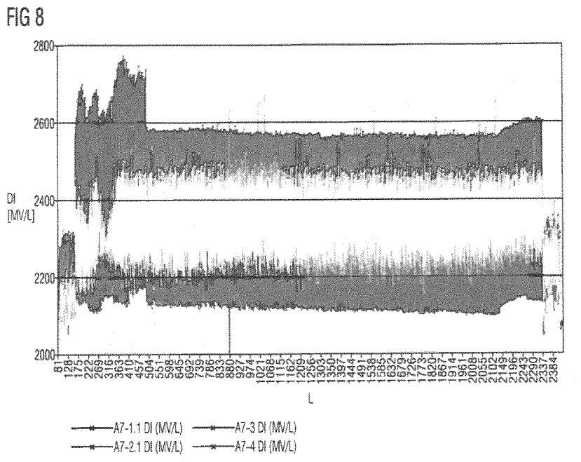

FIG. 8 shows a diagram composed of unprocessed data of a plurality of components,

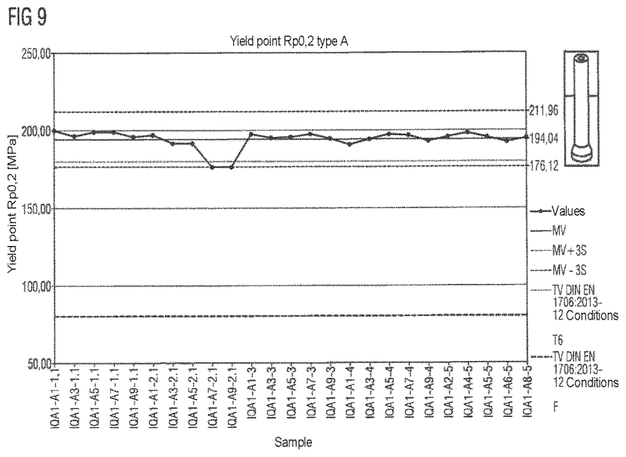

FIG. 9 shows a statistical evaluation of the material characteristic values recorded by means of destructive testing of components.

FIGS. 1 to 4 illustrate outputs of measured reflection values as known from the prior art. The reflection values represent the process luminous emission. The measurement values in FIGS. 1 to 4 originate from a melt pool monitoring system called “QM-Meltpool 2D” from “Concept Laser” from General Electric (GE). They show by way of example manufacturing process values of components which were subsequently subjected to at least one material test, in particular statistical destructive tests, and were found to be “good” or fault-free or “bad” or defective.

The assessment of the components with reference to FIGS. 1 to 4 as such is initially not possible.

The monitoring system records reflection values of the melt pool, here by means of a photodiode and a high-speed camera, in the process and stores them in a manner related to the melt pool position. On the basis of this, two data outputs are offered for the user:

1) PDF output (see FIG. 1 to FIG. 4) (also called 2D melt pool) of the average values and variances of the melt pool area of a layer, over all layers, and output of the average values of the diode intensity and the variance thereof per layer, over all layers. In this case, the upper curves in FIG. 1 to FIG. 4 depict said average values of the intensities or reflection values averaged over the layer, while the respective lower curves illustrate the variances thereof. These data can also be exported in a data file, here as a .csv file, from the installation. In principle, other suitable file formats are also conceivable.

Dedicated analyses can then be carried out on the basis of the exported files. A standardized procedure for data analysis is not designated at the present time. It is pointed out that the data are well suited, in the case of series production, that is to say upon repetition of the same production process, to assessing the curve profiles in a comparative manner. If the latter are similar, then it can be assumed that there were no problems. However, no acceptance and rejection characteristics are known.

2) Melt pool mapping, also called 3D melt pool: the respective reflection values (camera/diode signal) measured in a layer are stored in a position-related manner per layer. Afterward, voxel-based 3D models are generated from the layer maps, by means of image stack processing. There is no illustration of the possibility of processing a 3D model—generated from detected measurement values—of a component manufactured layer by layer by means of filtering certain grayscale levels, on the basis of which the user can carry out a dedicated quality assessment. Here, too, there are no standardized acceptance or rejection criteria. Furthermore, image stack processing has significant weaknesses as far as resolution (in the Z-direction), time investment and personal abilities of the respective user are concerned.

A fault indication depends on the choice of the opacity curves. This is defined by the respective operator and is therefore not a reliable indicator of a fault in the component. The quality assessment by means of image-stack-processed melt pool maps (prior art) is in no way standardized. An additional problem here is the poor resolution in the Z-direction:

The indication of defects is dependent on set opacity limit values of the operator. Defects have to be detected by way of a plurality of layer recordings; e.g. if a conspicuous feature was identified in one layer (according to the dedicated opacity setting), then it is necessary to inspect the underlying and overlying layers in a comparative manner to establish whether a corresponding fault indication is likewise present here at the same location. A fault should be suspected only if fault indications extend over a plurality of layers. However, this could also be down to the opacity limit values chosen (not a fault just an incorrect setting).

Consequently, on the filing date of this application, there were solution approaches but no solutions to the problem of PBF quality assessment.

The invention, then, is based on a method illustrated in accordance with FIG. 5 to FIG. 9, said method enabling an analytical quality assessment of the course of the process on the basis of the measurement values detected with respect to at least one measurement variable representing the process luminous emission. The diode signal was used by way of example for FIG. 5 to FIG. 9.

The method is subdivided into the following method steps in accordance with this exemplary embodiment:

1. Export of the above-described data relating to the average values—determined over all the layers—of the diode intensity (additionally or alternatively also the melt pool area in the case of a high-speed camera) and the variances thereof per layer into a suitable computing unit for the evaluation thereof. FIG. 5 shows by way of example an excerpt from such a data table. Column 1 lists the exposure step (Exp), column 2 lists the number of the layer, column 3 lists the average values of the diode intensity (DI) for the respective layer, while column 4 outputs the variance thereof.

The data should, if necessary, be separated according to exposure step, that is to say be assessed separately from one another into the categories of area and contour exposure (F) and (pure) contour exposure (C), in order to minimize the variation range. This gives rise to populations exhibiting normal distribution for the respective exposure step groups in accordance with FIG. 6.

In the so-called shell/core process, during manufacture the laser is conventionally operated with less power in a first layer in order to melt only the edge of the layer. In a subsequent, second layer, by contrast, said laser is operated with more power in order to melt the surface area of the first and second layers as well. Therefore, it appears to be expedient to separate the data according to exposure step, that is to say into pure contour exposure and contour and area exposure, and to process them. This is done in particular independently of the recording method (diode or camera). The moving average value of the variation coefficients can thus be formed separately according to exposure step.

FIG. 6 then shows a scatter diagram depicting the tuples formed from average value and standard distribution (here for example on the diode signals) over all the layers. It is evident that the tuples of good components follow a normal distribution, while the tuples of bad components vary significantly (abnormally). The different regions are attributable to the exposure steps (pure contour exposure or contour and area exposure in the respective exposure step).

2. Formation of the standard distribution by extracting the square root from the respective area variance (see FIG. 5, fifth column from the left, designated by DI SD).

3. Formation of the (if appropriate inverse) variation coefficient (layer quotient) “diode”: average diode intensity of the layer (MV/L)/diode intensity standard distribution of the layer (SD/L) or vice versa; see FIG. 5, sixth column from the left. Equally, a layer quotient “camera” (average melt pool area of the layer/standard distribution of the melt pool area of the layer or vice versa) could also be formed.

4. Forming a moving average through the individual (if appropriate inverse) variation coefficients (layer quotients) used for checking. Their number determines the length of the window and should be chosen as desired depending on the workpiece. FIG. 7 shows by way of example the plot of the inverse variation coefficients (average value/standard distribution) for diode and/or camera over a window of predefined layers (point clouds in FIG. 7), and also the moving average (MA COV) as solid lines in the point clouds.

5. If the moving average is approximately constant or in a narrow interval as in the case of the lower curves in FIG. 7, then the process runs stably. If the moving average deviates, that is to say if the curve profile is for example rising, falling, jagged, etc., like the upper curve in FIG. 7, then a problem with the process is present. The melt pool is disturbed. Mechanical properties of the components are then detrimentally affected; see also FIG. 9, in which the affected components exhibit significant deviations in their mechanical properties (characteristic values are 3σ away from the average value).

FIG. 8 shows for comparison the illustration of the average values of the diode intensities over the layers that results from the pure, unprocessed adoption of the CSV data. The diagram comprising unprocessed data of a plurality of components illustrates that the quality assessment on the basis of a simple comparison of the recorded signals does not give unambiguous information about the process quality and a quality indication is not possible given the noise present. The dark curve enclosing a light region represents a defective process.

FIG. 9 shows, as already indicated above, a statistical evaluation of the material characteristic values recorded by means of destructive testing of components. On the basis thereof, it is possible to verify the relationship between the process signal and the resulting component properties. The outliers are those which also exhibit greatly varying (if appropriate inverse) variation coefficients in the context of the signal analysis. Here two samples exhibit outliers—their mechanical properties are correlated with the signal profile.

One advantage of the invention consists in a numerically based, quantifiable assessment of the course of the process. The algorithm is simple and efficient. The functionality thereof was able to be demonstrated empirically on the basis of series of experiments. Complex processing algorithms and image analyses can be avoided as a result. The algorithm allows a direct quality prognosis. On account of its simplicity, the algorithm could likewise also be suitable for online process monitoring, so-called closed-loop control. Furthermore, as a result, process characteristics can be appraised rapidly and efficiently and adequate quality control can thus be carried out. Faults in the optical system of a PBF installation can be identified immediately and without focus measurement or laser power measurement, etc.

A device according to the invention for analyzing an additive manufacturing process, in particular a powder bed process, and for analyzing a workpiece produced, in particular layer by layer, by the additive manufacturing process, in particular layer by layer by a powder bed process, comprises at least one measurement value pickup for detecting measurement values concerning at least one process emission during the manufacture of the workpiece, in particular for detecting measurement values concerning at least one measurement variable representing the process luminous emission, and at least one computing unit suitably configured for forming average values and standard distributions from the measurement values concerning predefined volume elements of the workpiece, in particular also for forming variation coefficients for the respective volume elements and for forming a moving average value of the variation coefficients over a window of predefined volume elements, and for checking a distribution of the calculated standard distributions of a plurality of predefined volume elements as a measure of the process quality, in particular for checking the position of the moving average value within a predefined interval.

Average values and standard distributions concerning the measurement values of predefined volume elements are calculated and checked as to whether the calculated standard distributions concerning a plurality of predefined volume elements, in particular relating to the entire part to be checked of the component, exhibit a normal distribution. In this case, the distribution of the standard distributions is a measure of the process quality.

As a result of the three-dimensionality of the manufactured layers, the term volume elements is employed. One- or two-dimensional point or line elements cannot be detected. Areas of the individual layers correspond to slices through the workpiece (sectional planes). The thicknesses of the layers are often substantially constant in this case. Layers of different sizes arise as a result of areas of different sizes, and to a lesser extent as a result of different layer thicknesses. The measurement values containing the volume elements depict the two-dimensional area, but represent a volume element having a predefined layer thickness.

The process emissions detected by the measurement value pickups, such as the process luminous emission, for example, arise in a usually limited band, in the case of SRM e.g. in the near infrared range. The measurement value pickups are therefore suitable for detecting measurement values of a predefined spectrum.

1-14. (canceled)

15. A method for analyzing an additive manufacturing process, the method comprising:
detecting measurement values concerning at least one process emission during a manufacture of a workpiece;
calculating standard distributions of the measurement values of predefined volume elements of the workpiece; and
checking a distribution of the calculated standard distributions of a plurality of predefined volume elements as a measure of the process quality.

16. The method according to claim 15, which comprises deducing a fault-free process if a normal distribution of the calculated standard distributions of a plurality of predefined volume elements is present.

17. The method according to claim 15, which comprises calculating average values of the measurement values of the predefined volume elements and checking two-dimensional distributions of the calculated standard distributions and of the calculated average values as to whether the two-dimensional distributions exhibit a normal distribution, in order to deduce therefrom the process quality.

18. The method according to claim 15, which comprises forming from the measurement values concerning predefined volume elements average values and standard distributions and forming variation coefficients therefrom, forming a moving average value of the variation coefficients over a window of predefined volume elements and carrying out a check as to whether or not the moving average value lies within a predefined interval.

19. The method according to claim 18, which comprises, when the predefined interval is exceeded, deducing that a fault was present.

20. The method according to claim 18, which comprises checking a variance of moving average values over the window of predefined volume elements as a measure of the process quality.

21. The method according to claim 18, which comprises checking a profile of moving average values over the window of predefined volume elements as a measure of the process quality.

22. The method according to claim 18, wherein the predefined interval is predefined as a function of moving average values over the window of predefined volume elements.

23. The method according to claim 15, which comprises detecting measurement values concerning reflections of a melt pool.

24. The method according to claim 15, which comprises detecting and evaluating measurement values concerning a plurality of measurement variables.

25. A device for analyzing an additive manufacturing process and for analyzing a workpiece produced by the additive manufacturing process, the device comprising:
at least one measurement value pickup for acquiring measurement values concerning at least one process emission during a manufacture of the workpiece; and
at least one computing unit configured for forming average values and standard distributions from the measurement values concerning predefined volume elements of the workpiece.

26. The device according to claim 25, wherein said computing unit is suitably configured for checking a distribution of the calculated standard distributions of a plurality of predefined volume elements as a measure of a process quality.

27. The device according to claim 25, wherein said computing unit is suitably configured for forming variation coefficients for the respective volume elements, for forming a moving average value of the variation coefficients over a window of predefined volume elements, and for checking a position of the moving average value within a predefined interval.

28. The device according to claim 25, which comprises at least one photodiode and/or at least one high-speed camera for detecting the measurement values concerning the at least one process emission during the manufacture of the workpiece.
